(19) United States
(12) Patent Application Publication
(10) Pub. No.: US 2020/0387920 A1
(43) Pub. Date: Dec. 10, 2020

(54) METHODS AND SYSTEMS FOR MANAGING A SOCIAL COMMERCE REWARDS PLATFORM

(71) Applicant: Konnect Mobile Communications Inc., Montreal (CA)

(72) Inventor: William Lee COYLE, Montreal (CA)

(73) Assignee: Konnect Mobile Communications Inc., Montreal, QC (CA)

(21) Appl. No.: 16/767,163

(22) PCT Filed: Nov. 28, 2017
(86) PCT No.: PCT/CA2017/000253

§ 371 Date: May 27, 2020

(51) Int. Cl. G06Q 30/02; H04L 12/58

(52) U.S. Cl. CPC G06Q 30/0214; G06Q 30/0236; G06Q 30/0239; H04L 51/32

(57) ABSTRACT

The present invention provides a method and systems for managing a social commerce rewards platform over an electronic communication network, the method having the steps of prior to the completion of an electronic commercial transaction between a user device and a commercial entity device, electronically sending a promotion to the user device, the promotion related to the commercial entity, the promotion containing at least one application program interface connection, the at least one application program interface connection adapted to share the promotion to the at least one primary social network, and if the promotion is shared by the user from the user device with at least one of the at least one primary social network, an incentive is automatically electronically transferred from the enterprise account to a server account and subsequently a primary fractional incentive is automatically electronically transferred from the server account to the user account.

### FIELD

The present invention relates to electronic commerce in the context of social networking over an electronic computer network. More specifically, the present invention related to methods and systems for providing a social commerce rewards platform for use in connection with electronic mobile devices that permits users to earn incentives based on the level of promotional engagement attained within that user's pre-existing social network prior to or following a successful electronic commercial transaction.

### BACKGROUND

Electronic commercial transactions have slowly supplanted cash transactions in both online and traditional “brick and mortar” commercial establishments for a variety of reasons. When a commercial transaction can be conducted electronically, the customer is no longer required to have sufficient funds on hand in the form of cash and the vendor is not required to store and maintain sufficient cash on hand to facilitate the transaction.

In the context of online transactions over the internet, electronic commercial transactions permit the vendor and the customer (or, for example, a transferor and a transferee) to be physically separated by significant distance. It will also be readily understood that a cash transaction is typically limited to single currency (or a preselected group of currencies) while an electronic transaction can theoretically be currency agnostic. Moreover, there are significant costs to the production, issuance, maintenance, transfer and storage of physical currency.

Accordingly, a number of solutions have been developed to fulfill the clear advantages that electronic commercial transactions offer participants in the modern global economy. Many of these solutions provide for the execution of electronic commercial transactions using a user device, which can take a number of forms.

If a transaction is completed or about to be completed using a user device, it will be understood that the user “captive” and is likely to be receptive to further promotional offers from the commercial entity that was involved in the transaction.

Moreover, given the advent of social media, it is contemplated that the user could likely be a member of a number of social media networks, and as such the user is similarly more likely to share a promotion relating to a commercial entity through these social networks in the period immediately following the successful completion of an electronic transaction between that commercial entity and the user.

It is also contemplated that the user would be more likely to share a promotion through a social network if there is an incentive to be automatically and electronically collected in return. On the other hand, a commercial entity is conceivably willing to provide such an incentive in return for successful social media “shares” and the increased visibility that comes with a social media posting. If this incentive is provided to the user in an automatic and electronic matter, it is foreseeable that both users and commercial entities would be more willing to adopt this system given the ease of use.

Specifically, it is contemplated that a successful social media “share” can be assessed by how many users of a social network engage with the initially shared promotion and, ideally, how many users of a social network in turn share the promotion to their own social networks, and so on. In this way, the promotion can be shared in a “viral” manner.

As will be readily understood by the skilled person, this “virality” is highly desirable from a marketing perspective and a commercial entity is foreseeably willing to offer economic incentives to users who facilitate the sharing of such promotions in a viral manner.

As such, there is need for methods and systems for managing a social commerce rewards platform that offers a promotion to an initial user who is about to or has recently completed an electronic transaction with a commercial entity and facilitate the sharing of this promotion through various levels of social networks while allowing the various users of the social media networks to automatically electronically collect incentives that are offered by the commercial entity that initially offered the promotion.

### BRIEF SUMMARY

It is contemplated that the present invention can provide methods and systems for managing a social commerce rewards platform over an electronic communication network that offers a promotion to an initial user who has recently completed an electronic transaction with a commercial entity and facilitate the sharing of this promotion through various levels of social media networks while allowing the various users of the social media networks to automatically and electronically collect incentives that are offered by the commercial entity that initially offered the promotion.

In at least one embodiment, the present invention provides methods and systems for managing a social commerce rewards platform over an electronic communication network, the methods having the steps of: prior to the completion of an electronic commercial transaction between a user device and a commercial entity device over the electronic communication network through a central distribution server, the user device having electronic access to a user account hosted with the central distribution server and at least one primary social network, each at least one primary social network including at least one secondary user, the commercial entity device having electronic access to an enterprise account, electronically sending a promotion to the user device over the electronic communication network through the central distribution server, the promotion related to the commercial entity, the promotion containing at least one application program interface connection, the at least one application program interface connection adapted to share the promotion to the at least one primary social network, and if the promotion is shared by the user from the user device with at least one of the at least one primary social network over the electronic communication network, an incentive is automatically electronically transferred from the enterprise account to a server account and subsequently a primary fractional incentive is automatically electronically transferred from the server account to the user account.

In at least one embodiment, the present invention provides methods and systems for managing a social commerce rewards platform over an electronic communication network, the systems including a user device, the user device having electronic access to a user account hosted with the central distribution server and at least one primary social network, each at least one primary social network including at least one secondary user, a commercial entity device, the commercial entity device having electronic access to an enterprise account, and a central distribution server, the user device, the commercial entity device and the central distribution server in electronic communication over the electronic communication network, such that prior to the completion of an electronic commercial transaction between the user device and the commercial entity device over the electronic communication network through the central distribution server, the central distribution server adapted to electronically send a promotion to the user device over the electronic communication network, the promotion related to the commercial entity, the promotion containing at least one application program interface connection, the at least one application program interface connection adapted to share the promotion to the at least one primary social network; and if the promotion is shared by the user from the user device with at least one of the at least one primary social network over the electronic communication network, an incentive is automatically electronically transferred by the central distribution server from the enterprise account to a server account and subsequently a primary fractional incentive is automatically electronically transferred by the central distribution server from the server account to the user account.

### BRIEF DESCRIPTION OF THE DRAWINGS

The present invention will be better understood in connection with the following drawings, in which:

FIG. 1 is a diagram of one embodiment of an electronic communication network in accordance with the present invention;

FIG. 2 is a diagram of an embodiment of a method for managing a social commerce rewards platform through a primary social network over an electronic communication network in accordance with the present invention;

FIG. 3 is a diagram of another embodiment of a method for managing a social commerce rewards platform through a primary social network over an electronic communication network in accordance with the present invention;

FIG. 4 is a diagram of another embodiment of a method for managing a social commerce rewards platform through a secondary social network over an electronic communication network in accordance with the present invention; and

FIG. 5 is a diagram of another embodiment of a method for managing a social commerce rewards platform through a tertiary social network over an electronic communication network in accordance with the present invention.

### DETAILED DESCRIPTION OF THE EMBODIMENTS

In at least one embodiment, it is contemplated that the present invention provides methods and systems for managing a social commerce rewards platform over an electronic communication network that offers a promotion to an initial user who is about to complete or who has recently completed an electronic transaction with a commercial entity and facilitate the sharing of this promotion through various levels of social media networks while allowing the various users of the social media networks to automatically and electronically collect incentives that are offered by the commercial entity that initially offered the promotion.

In at least one embodiment the present invention provides a method and system having at least a first user device and a first commercial entity device in electronic communication with an electronic communication network and in electronic communication with a central distribution server.

It is contemplated that the present invention can be executed by way of enterprise software that is run as web-based software-as-a-service through the central distribution server, through mobile software applications loaded on user devices and as enterprise software within an organization among any other types of software arrangements or hybrid software arrangements that will be readily appreciated by the skilled person.

It is contemplated that the present invention provides a method for managing a social commerce rewards platform over an electronic communication network through a central distribution server. In at least one embodiment, the present method is initiated prior to the completion of an electronic commercial transaction between a user device and a commercial entity device over an electronic communication network. In other embodiments it is contemplated that the present method is initiated following the completion of an electronic commercial transaction between a user device and a commercial entity device over an electronic communication network.

In the context of the present invention, a suitable electronic commercial transaction can take a number of forms including, but not limited to, an electronic fund transfer from a first user to second user, an electronic payment of funds for a purchase executed between a vendor and a customer, an electronic payment of a bill between a customer and an institution, an withdrawal or deposit of funds from a financial institution and a user, an automated teller machine (ATM) withdrawal or deposit, and a multi-party electronic commerce transaction, among any other type of suitable electronic transaction between at least two parties that will be readily understood by the skilled person.

It is further contemplated that an electronic transaction can be between a first consumer user and a second consumer user (C2C), between a consumer user and a business (B2C) or between a first business and a second business (B2B), among other suitable electronic commercial transactions as required by the particular end-user application of the present invention.

In some embodiments, it is contemplated that an electronic commercial transaction can be executed wireless between remotely located user devices and commercial entity devices over an electronic communication network, or alternatively can be executed directly between user devices and commercial entity devices that are in near field communication, among other arrangements that will be readily appreciated by the skilled person.

In at least one embodiment it is contemplated that user devices and commercial entity devices can communicate electronically in close proximity by way of scanning an electronic code (such as, but not limited to, a UPC, QR or customized code) that contains encoded information necessary for facilitating the transaction.

It is further contemplated that electronic commercial transactions can take place through a variety of electronic communication network formats. For example, an electronic commercial transaction can take place through SMS, device-to-device near field communication (“NFC”), wireless application protocols (WAPs), through the internet and within a mobile application environment (including but not limited to Android®, Apple® and Blackberry® applications), among any other suitable electronic communication network format as will be readily appreciated by the skilled person.

In the context of the present invention, it is contemplated that a suitable user device and a suitable commercial entity device can be any suitable computing device having data input capability, electronic communication network connectivity and support for the execution of an electronic commercial transaction as discussed herein. In at least one embodiment, it is contemplated that a suitable user device will be adapted to operate software in order to function as an electronic wallet.

For example, a suitable user device or a suitable commercial entity device could include, but is not limited to, a user device such as a smartphone, a desktop computer terminal, a tablet computer, a laptop, a digital assistant, a smart TV, a wearable device and a point-of-sale device, among any other suitable user devices adapted to run software in order to function as an electronic wallet that will be readily understood by the skilled person.

As will be readily appreciated by the skilled person, a suitable user device or a suitable commercial entity device can have, but is not limited to, input means (in the form of, for example, a touchscreen, microphone, or keyboard) wireless or hardwired connectivity (in the form of, for example, a network interface controller, a wireless network interface controller, a broadband modem, or a radio transceiver), a power source, temporary, permanent and read-write data storage and media playback capability on output means (in the form of, for example, a speaker or video screen).

Moreover, in the present context a suitable electronic communication network in accordance with the present invention is a network that permits electronic communication between suitably connected user devices and commercial entity devices. Suitable electronic communication networks could be a global wireless and hardwired network such as the internet, an internal hard-wired local area network with an institution or a private network of wirelessly connected user devices, among a wide variety of other arrangements that will be readily appreciated by the skilled person. It is contemplated that electronic communication over the network can enable secure or insecure and encrypted or unencrypted electronic communications, depending on the needs of the particular end-user application.

In the context of the present invention, a suitable central distribution server will be a computing device having electronic communication network connectivity and electronic access to physical data storage. It is contemplated that the central distribution server could be one or a number of suitable servers, and can be located in single or multiple locations, suitably connected to the user device through the electronic communication network.

In at least one embodiment, it is contemplated that the user device (i.e. a device that participates in the electronic transaction) is authenticated with the central distribution server. In some embodiments, authentication can occur between the user device and the central distribution server, while in other embodiments the authentication can be performed completely by a single device, or by two or more devices in electronic communication with one another, among other arrangements that will be readily appreciated by the skilled person.

In the context of the present invention, authentication of a user device can take a variety of forms. In at least one embodiment, authentication can involve cross-referencing input authentication information provided by the user of the user device with reference authentication information stored on the central distribution server in connection with the corresponding user account. It is contemplated that authentication information can include but is not limited to a password or other alphanumeric string, personal information and a fingerprint, among any other suitable authentication information that will be readily appreciated by the skilled person. It is also contemplated that a user device may be authenticated initially and remain in a constantly authenticated state that is detected by the central distribution server as discussed in further detail below.

It is further contemplated that the user device has electronic access to a user account hosted with the central distribution server. In the context of the present invention, a suitable user account can take a variety of forms depending on the needs of the particular end-user application. For example, in one embodiment the user account is a client account associated with the central distribution server that the user accesses through a mobile software application or application program interface. In others, the user account may in fact be an electronic account that the user accesses through a mobile software application or application program interface that is placed with a third-party institution, among other arrangements that will be readily understood by the skilled person.

It is contemplated that the user account can be a client account, an enterprise account, a third-party financial institution account, a pre-loaded cash account and a non-currency rewards account, among any other types of accounts that will be readily appreciated by the skilled person. The account can be comprised or any currency or currencies, denominations and can be comprised of monetary amounts or non-monetary amounts (such as rewards or loyalty points) as will be readily understood by the skilled person. It is contemplated that the user device has secure and encrypted communication with the associated user account however in some embodiments it is contemplated that such protections are not required, depending on the needs of the end-user application.

In some embodiments, it is contemplated that the user accesses an account through a mobile software application running on the user device while in other embodiments the user accesses an account through an application program interface with a third-party institution, among other arrangements that will be readily appreciated by the skilled person.

It is also contemplated that the user device has electronic access to at least one social media network over the electronic communication network. Examples of suitable social networks can include, but are not limited to, Twitter®, Facebook®, LinkedIn®, Instagram®, SnapChat®, WeChat® and a user's personal email address network, among any other suitable social network that permits a user to share a promotion in an electronically-connected manner as will be readily understood by the skilled person.

In at least one embodiment, it is contemplated that each at least one social network includes at least one additional user, thereby creating an electronic social network between the initial primary user (involved in the electronic commercial transaction) and at least one secondary user.

It is moreover contemplated that the commercial entity device has electronic access to an enterprise account. For the purposes of the present invention, it is contemplated that the enterprise account is generally analogous to the client account and can include, but is not limited to, a third-party financial institution account, a pre-loaded cash account and a non-currency rewards account, among any other types of enterprise accounts that will be readily appreciated by the skilled person. The enterprise account can be comprised or any currency or currencies, denominations and can be comprised of monetary amounts or non-monetary amounts (such as rewards or loyalty points) as will be readily understood by the skilled person. It is contemplated that the commercial entity device has secure and encrypted communication with the associated commercial entity account however in some embodiments it is contemplated that such protections are not required, depending on the needs of the end-user application.

In some embodiments, it is next contemplated that the present method can be initiated upon the completion of a predetermined occurrence that occurs prior to the completion of a successful electronic commercial transaction between the user and the commercial entity. Examples of suitable predetermined occurrences can include, but are not limited to, the receipt of transaction completion information, a predetermined period of time passing following the receipt of transaction completion information, the successful completion of an electronic transaction, a predetermined period of time passing following the successful completion of an electronic transaction, the user travels a predetermined distance from the physical location of a commercial entity that was party to a recently and successfully completed electronic transaction, and the user approaches within a predetermined distance of another predefined commercial entity, among any other suitable predetermined occurrence that can occur prior to the completion of an electronic transaction or following the successful completion of an electronic transaction between a user and a commercial entity as will be readily understood by the skilled person.

In these embodiments, once the predetermined occurrence occurs, it is contemplated that a promotion is sent to the user device over the electronic communication network through the central distribution server. In at least one embodiment, it is contemplated that the promotion is related to the commercial entity that was party to the initial, electronic commercial transaction. Examples of suitable promotions can include, but are not limited to, a sales promotion (i.e. buy one, get one free), a discount promotion (i.e. X % off the next purchase), a membership fee promotion (i.e. new membership fees reduced by X %), an event based promotion (i.e. free ticket to an event with purchase) and a non-monetary rewards promotion (i.e. double the loyalty points with next purchase), among any other suitable incentives that compliment an electronic commercial transaction as will be readily appreciated by the skilled person.

It is contemplated that a suitable promotion includes at least one application program interface connection. In some embodiments the application program interface connection is a hyperlink. In the context of the present invention, it is contemplated that an application program interface connection can be any suitable link that the user can directly follow either by clicking, tapping, or hovering over the application program interface connection “button” or text. In the context of the present invention, it is contemplated that the application program interface connection will provide the ability to “share” promotion to at least one of the user's social networks, as will be readily understood by the skilled person.

In the context of a present invention, it will be readily understood that a “share” is contemplated as any suitable pushing of the promotion from the user to that user's social network. It will be appreciated that the form of the share will differ based on the protocol or architecture employed by a particular social media network. In other words, this could be a posting to a user's visible account profile page (i.e. a Twitter® tweet, Facebook® post or an Instagram® post) or a suitable share could be a user sending the promotion to a number of secondary users in an traditional email or an SMS message, as will be readily understood by the skilled person.

It is contemplated that the user can choose to “always share” subsequent promotions (either associated with a particular commercial entity or all promotions generally) so that the user is not subsequently prompted to share future promotions and all such future promotions can be automatically shared. On the other hand, it is contemplated that the user can choose to “never share” subsequent promotions so that the user is not subsequently prompted to share future promotions and all such future promotions will not be shared.

Once the promotion has been successfully shared by the user to at least one of the user's social networks, it is contemplated that an incentive can be automatically electronically transferred from the enterprise account, which is associated with the commercial entity party to the initial electronic transaction, to a server account. It is contemplated that the server account is an account hosted with the central distribution server and, in the context of the present invention, is electronically accessed by a third-party that was not initially party to the electronic commercial transaction. In at least one embodiment, it is contemplated that the server account is electronically accessed by a third-party administrator of the central distribution server and, by extension, the administrator of the overarching methods and systems described by the present invention. In this way, it is contemplated that the commercial entity can compensate the third-party administrator for the successful sharing of the promotion by the user to at least one of the user's social networks.

For the purposes of the present invention, it is contemplated that the server account is generally analogous to the client account and the enterprise account and can include, but is not limited to, a third-party financial institution account, a pre-loaded cash account and a non-currency rewards account, among any other types of server accounts that will be readily appreciated by the skilled person. The server account can be comprised or any currency or currencies, denominations and can be comprised of monetary amounts or non-monetary amounts (such as rewards or loyalty points) as will be readily understood by the skilled person. It is contemplated that the server has secure and encrypted communication with the associated commercial entity account however in some embodiments it is contemplated that such protections are not required, depending on the needs of the end-user application.

Examples of suitable incentives can include, but are not limited to, a cash or payment incentive, a “cash back” or discount incentive, a commercial incentive (i.e. a free product offer) and non-monetary incentive (i.e. loyalty points) among any other suitable incentive that will be readily appreciated by the skilled person.

Once the incentive is automatically electronically transferred to the server account, it is further contemplated that a fractional incentive can be automatically electronically transferred from the server account the user account. In this way, it is contemplated that the third-party administrator of the system can in turn compensate the user for successfully sharing the promotion to that user's at least one social network. Moreover, it is contemplated that a fractional incentive is merely a fractional analogue of the suitable incentives discussed herein.

It is contemplated that the present invention provides methods and systems to encourage the “viral” sharing of a promotion related to a commercial entity. In other words, the present methods and systems are contemplated to incentivize the sharing of a promotion through multiple levels of a social network, or in other words, through multiple connected user's personal social networks.

It is contemplated that after a promotion has been shared to at least one social network by a primary user (that is, a user who is initially party to an electronic commercial transaction) that promotion may in turn be shared by any of the secondary users that comprise the primary user's social network. It is contemplated that this subsequently “shared” promotion also includes an application program interface connection and is otherwise can be considered analogous to the promotion that was initially shared by the first user as discussed previously.

Once the promotion has been successfully shared by a secondary user to at least one of the secondary user's social networks, it is contemplated that a secondary fractional incentive can be automatically electronically transferred from the server account to a secondary user account. In this way, it is contemplated that the third-party administrator of the system can in turn compensate the secondary user for successfully sharing the promotion to that secondary user's at least one social network. Moreover, it is contemplated that a secondary fractional incentive is merely another fractional analogue of the suitable incentives discussed herein.

It is contemplated that after a promotion has been shared to at least one social network by a secondary user (that is, a user who was not initially party to an electronic commercial transaction) that promotion may in turn be shared by any of the tertiary users that comprise the secondary user's social network. It is contemplated that this subsequently “shared” promotion also includes an application program interface connection and is otherwise analogous to the shared promotions that was initially shared by the first user and subsequently shared by the secondary user as discussed previously.

Once the promotion has been successfully shared by a tertiary user to at least one of the tertiary user's social networks, it is contemplated that a tertiary fractional incentive can be automatically electronically transferred from the server account to a tertiary user account. In this way, it is contemplated that the third-party administrator of the system can in turn compensate the tertiary user for successfully sharing the promotion to that user's at least one social network. Moreover, it is contemplated that a tertiary fractional incentive is merely another fractional analogue of the suitable incentives discussed herein.

In this way, it is contemplated that the present invention provides methods and systems for managing a social commerce rewards platform over an electronic communication network that offers a promotion to an initial user who is about to complete or who has recently completed an electronic transaction with a commercial entity and facilitate the sharing of this promotion through various levels of social media networks while allowing the various users of the social media networks to automatically and electronically collect incentives that are offered by the commercial entity that initially offered the promotion.

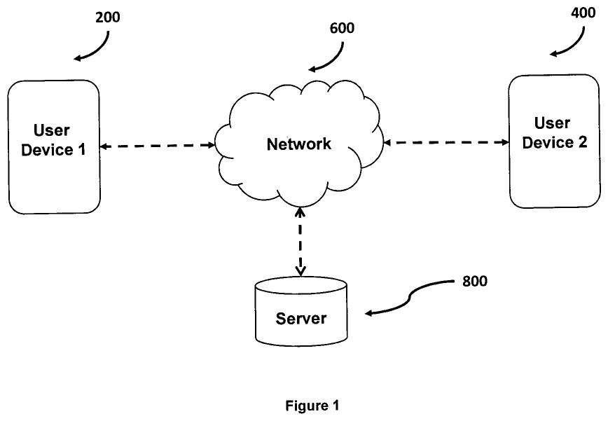

With reference to FIG. 1, at least one embodiment of a system for use in connection with the present invention is illustrated. In this embodiment, a first mobile device 200 is in wireless electronic communication with a second mobile device 400 through an electronic communication network 600. In this embodiment, user devices 200 is a mobile smartphone device adapted to function as an electronic wallet and user device 400 is a point-of-sale device both of which are in electronic communication network 600, which is a wireless mobile communication network.

In this embodiment, mobile devices 200, 400 are also in wireless electronic communication with a central distribution server 800 through electronic communication network 600.

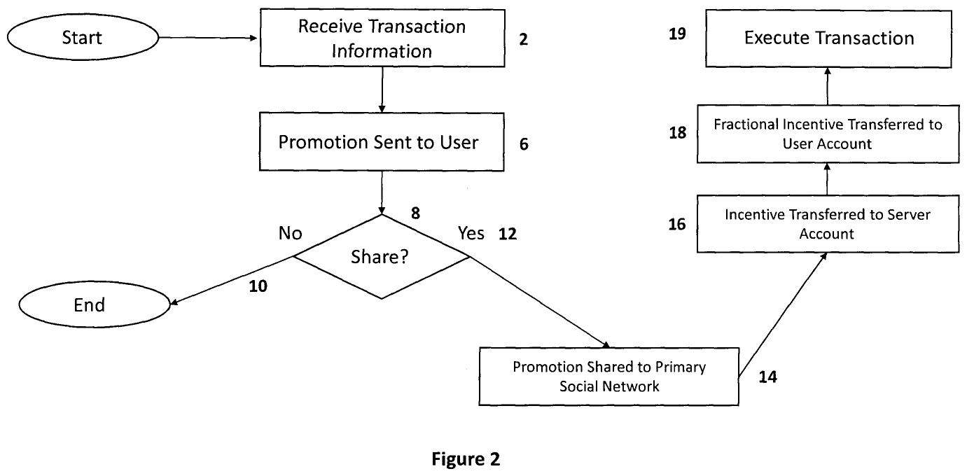

Turning to FIG. 2, at least one embodiment of the present invention is illustrated. In this embodiment, the method is initiated upon the detection of the imminent completion of an electronic commercial transaction between a user and a commercial entity 2. In at least one embodiment, this can be achieved when transaction information is received from a commercial entity device by the central distribution server indicating that the completion of an electronic commercial transaction between a user and a commercial entity is imminent. The user is automatically sent a promotion related to the commercial entity 6. As discussed herein, it is contemplated that the promotion can be sent to the user in any number of suitable ways including in the form of a message within a mobile application or as an automatically generated email or SMS message, depending on the software architecture employed by the end user application of the present invention.

It is contemplated that the promotion includes at least one application program interface connection, and the user is invited to share the promotion through at least one social network via the at least one application program interface connection 8. As will be readily understood by the skilled person, it is contemplated that the user may already be authenticated with the various third party social networking software via an application program interface or other known means, or alternatively the user may be required to sign-in or authenticate with the social networking software before the promotion can be shared to the user's social network.

Should the user choose not to share the promotion to that user's social network 10, the present method can terminate. In some embodiments it is contemplated that the user can select to always share subsequent promotions or alternatively the user can select to never share any subsequent promotions.

On the other hand, if the user chooses to share the promotion to that user's social network 12, the promotion can be shared to the user's social network 14.

Once the promotion has been successfully shared to at least one of the user's social networks 14 via the application program interface connection provided in the promotion, an incentive can be automatically electronically transferred from an enterprise account associated with the commercial entity to a server account that is stored with the central distribution server 16.

As discussed previously, it is contemplated that the server account can be accessed by a third-party who, in some embodiments, can be the administrator of the central distribution server and, as a result, the present method and system as a whole. In this way, the third-party administrator can be compensated for a successful share of the promotion by the user to that user's social network.

In at least one embodiment, it is contemplated that the incentive is a cash incentive, among other arrangements that will be readily understood by the skilled person and as discussed herein.

In turn, once the incentive is automatically electronically transferred from the enterprise account associated with the commercial entity to the server account 14, a fractional incentive can be automatically electronically transferred from the server account to the user account 18 and the electronic commercial transaction can be executed 19 by any known means. In this way, the user is incentivized and compensated for a successful share to that user's social network.

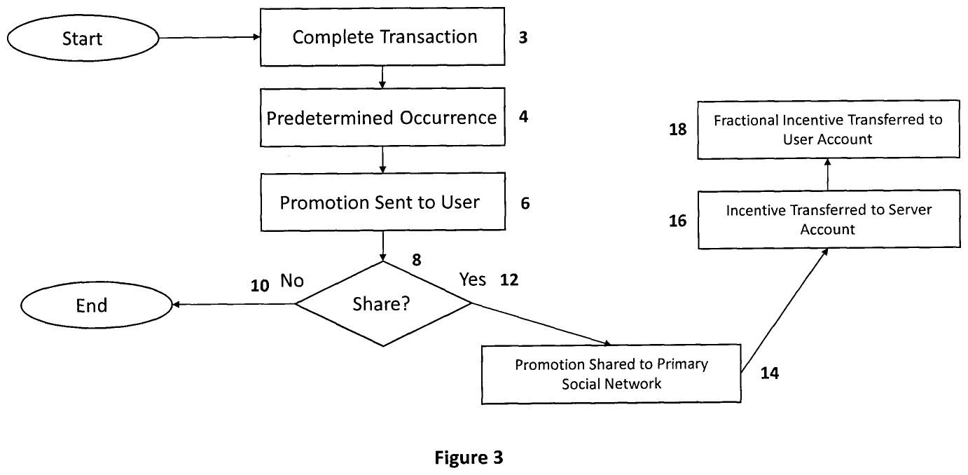

Turning to FIG. 3, another embodiment of the present invention is illustrated. In this embodiment, the method is initiated upon completion of an electronic commercial transaction between a user and a commercial entity 3. Upon completion of a predetermined occurrence 4, the user is automatically sent a promotion related to the commercial entity 6. As discussed herein, it is contemplated that the promotion can be sent to the user in any number of suitable ways including in the form of a message within a mobile application or as an automatically generated email or SMS message, depending on the software architecture employed by the end user application of the present invention.

It is contemplated that the promotion includes at least one application program interface connection, and the user is invited to share the promotion through at least one social network via the at least one application program interface connection 8. As will be readily understood by the skilled person, it is contemplated that the user may already be authenticated with the various third party social networking software via an application program interface or other known means, or alternatively the user may be required to sign-in or authenticate with the social networking software before the promotion can be shared to the user's social network.

Should the user choose not to share the promotion to that user's social network 10, the present method can terminate. In some embodiments it is contemplated that the user can select to always share subsequent promotions or alternatively the user can select to never share any subsequent promotions.

On the other hand, if the user chooses to share the promotion to that user's social network 12, the promotion can be shared to the user's social network 14.

Once the promotion has been successfully shared to at least one of the user's social networks 14 via the application program interface connection provided in the promotion, an incentive can be automatically electronically transferred from an enterprise account associated with the commercial entity to a server account that is stored with the central distribution server 16.

As discussed previously, it is contemplated that the server account can be accessed by a third-party who, in some embodiments, can be the administrator of the central distribution server and, as a result, the present method and system as a whole. In this way, the third-party administrator can be compensated for a successful share of the promotion by the user to that user's social network.

In at least one embodiment, it is contemplated that the incentive is a cash incentive, among other arrangements that will be readily understood by the skilled person and as discussed herein.

In turn, once the incentive is automatically electronically transferred from the enterprise account associated with the commercial entity to the server account 14, a fractional incentive can be automatically electronically transferred from the server account to the user account 18. In this way, the user is incentivized and compensated for a successful share to that user's social network.

### Example 1

A user is about to complete the sale of groceries by way of an electronic transaction with a local store. Before the transaction is concluded electronically between the user's smart phone and a point-of-sale unit present at the local store, the user is sent a message via a third-party mobile software application installed on the user's smart phone offering a 10% discount on the user's next purchase at the local store if the user shares the promotion through Twitter®, Facebook®, Instagram® or LinkedIn®. The user selects an application program interface connection titled “Tweet” and the promotion is automatically posted (or “tweeted”) to the user's network of Twitter® followers.

Upon automatically posting of the promotion to the user's network of Twitter® followers, a cash incentive is automatically electronically transferred from an account associated with the local store and an account associated with the third-party software provider. Once this transfer is completed, a fraction of that cash incentive is in turn automatically electronically transferred from the account associated with the third-party software provider to the user's account.

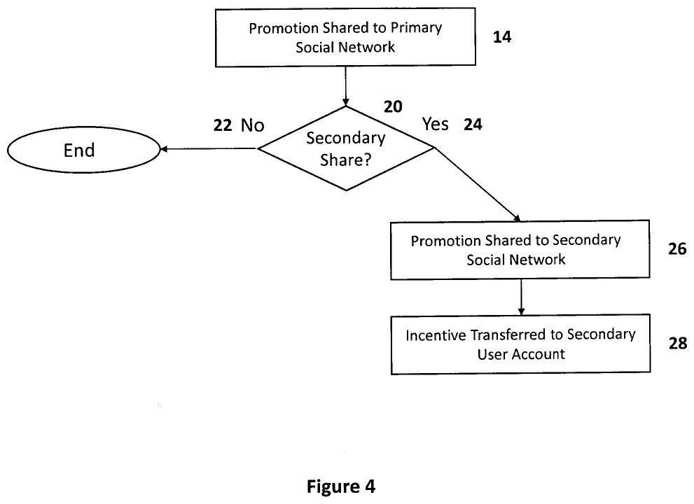

Once the fractional incentive is automatically transferred from the server account to the user account 18 the present method can proceed to another embodiment. With reference to FIG. 4, once the promotion has been successfully shared to at least one of the user's social networks 14 via the application program interface connection provided in the promotion, any secondary user in the first user's social network is invited to additionally share the promotion through the secondary user's at least one social network 20 via the at least one application program interface connection.

As will be readily understood by the skilled person, it is contemplated that the secondary user may already be authenticated with the various third party social networking software via an API or other known means, or alternatively the secondary user may be required to sign-in or authenticate with the social networking software before the promotion can be shared to the secondary user's social network.

Should the user choose not to share the promotion to that secondary user's social network 22, the present method can terminate.

On the other hand, if the promotion has been successfully shared the at least one of the secondary user's social networks 24 via the application program interface connection provided in the promotion, the promotion can be shared to the secondary user's social network 26 and a secondary fractional incentive can be automatically electronically transferred from the server account to the secondary user account 28. In this way, the secondary user is also incentivized and compensated for a successful share to that secondary user's social network.

### Example 2

A secondary user who follows the user in Example 1 on Twitter® sees the 10% discount promotion and decides to post that promotion to the secondary user's Facebook® page. As such, the secondary user selects a application program interface connection titled “Post to Facebook” and posts the promotion on the secondary user's Facebook® feed, where a number of Facebook® users who are following the secondary user see the posted promotion.

Upon posting of the promotion to the user's network of Facebook® friends, a fractional secondary cash incentive is in turn automatically electronically transferred from the account associated with the third-party software provider to the secondary user's account.

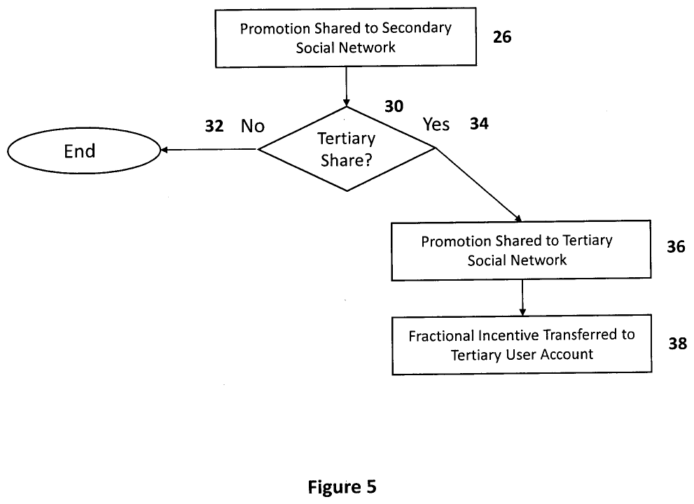

Once the secondary fractional incentive is automatically electronically transferred from the server account to the secondary user account 28 the present method can proceed to yet another embodiment. With reference to FIG. 5, once the promotion has been successfully shared to at least one of the secondary user's social networks 26 via the application program interface connection provided in the promotion, any tertiary user in the secondary user's social network is invited to additionally share the promotion through the tertiary user's at least one social network 30 via the at least one application program interface connection.

As will be readily understood by the skilled person, it is contemplated that the tertiary user may already be authenticated with the various third party social networking software via an API or other known means, or alternatively the tertiary user may be required to sign-in or authenticate with the social networking software before the promotion can be shared to the tertiary user's social network.

Should the user choose not to share the promotion to that secondary user's social network 32, the present method can terminate.

On the other hand, if the promotion has been successfully shared to at least one of the tertiary user's social networks 34 via the application program interface connection provided in the promotion, the promotion can be shared to the tertiary user's social network 36 and a tertiary fractional incentive can be automatically transferred from the server account to the secondary user account 38. In this way, the tertiary user is also incentivized and compensated for a successful share to that tertiary user's social network.

### Example 3

A tertiary user who is “friends” with the secondary user in Example 2 through Facebook® sees the 10% discount promotion and decides to post that promotion to the tertiary user's Instagram® account. As such, the tertiary user selects an application program interface connection titled “Instagram” and posts the promotion on the tertiary user's Instagram® account, where a number of Instagram® followers of the secondary user's account see the posted promotion. Upon posting of the promotion to the user's network of Instagram® followers, a tertiary fractional cash incentive is in turn automatically transferred from the account associated with the third-party software provider to the tertiary user's account.

While the present invention has been described with reference to particular embodiments it will be apparent to anyone skilled in the art that there are many permutations and combinations of combining the primary response variables to achieve particular benefits. All such permutations and combinations are considered to be within the sphere and scope of this invention as defined in the claims appended hereto.

1. A method for managing a social commerce rewards platform over an electronic communication network, the method having the steps of:
prior to the completion of an electronic commercial transaction between a user device and a commercial entity device over the electronic communication network through a central distribution server, the user device having electronic access to a user account hosted with the central distribution server and at least one primary social network, each at least one primary social network including at least one secondary user, the commercial entity device having electronic access to an enterprise account;
electronically sending a promotion to the user device over the electronic communication network through the central distribution server, the promotion related to the commercial entity, the promotion containing at least one application program interface connection, the at least one application program interface connection adapted to share the promotion to the at least one primary social network; and
if the promotion is shared by the user from the user device with at least one of the at least one primary social network over the electronic communication network, an incentive is automatically electronically transferred from the enterprise account to a server account and subsequently a primary fractional incentive is automatically electronically transferred from the server account to the user account.

2. The method of claim 1, wherein if at least one of the at least one secondary user in the at least one primary social network subsequently shares the promotion over the electronic communication network to at least one secondary social network, each at least one secondary social network including at least one tertiary user, a secondary fractional incentive is automatically electronically transferred from the server account to a secondary user account associated with the secondary user and stored with the central distribution server.

3. The method of claim 1, wherein if at least one of the at least one tertiary user in the at least one secondary social network subsequently shares the promotion over the electronic communication network to at least one tertiary social network, each at least one tertiary social network including at least one quaternary user, a tertiary fractional incentive is automatically electronically transferred from the server account to the tertiary user account associated with the tertiary user and stored with the central distribution server.

4. The method of claim 1, wherein the promotion is sent to the user device over the electronic communication network upon the completion of a predetermined occurrence.

5. A method for managing a social commerce rewards platform over an electronic communication network, the method having the steps of:
upon the completion of an electronic commercial transaction between a user device and a commercial entity device over the electronic communication network through a central distribution server, the user device having electronic access to a user account hosted with the central distribution server and at least one primary social network, each at least one primary social network including at least one secondary user, the commercial entity device having electronic access to an enterprise account;
electronically sending a promotion to the user device over the electronic communication network through the central distribution server, the promotion related to the commercial entity, the promotion containing at least one application program interface connection, the at least one application program interface connection adapted to share the promotion to the at least one primary social network; and
if the promotion is shared by the user from the user device with at least one of the at least one primary social network over the electronic communication network, an incentive is automatically electronically transferred from the enterprise account to a server account and subsequently a primary fractional incentive is automatically electronically transferred from the server account to the user account.

6. The method of claim of claim 5, wherein if at least one of the at least one secondary user in the at least one primary social network subsequently shares the promotion over the electronic communication network to at least one secondary social network, each at least one secondary social network including at least one tertiary user, a secondary fractional incentive is automatically electronically transferred from the server account to a secondary user account associated with the secondary user and stored with the central distribution server.

7. The method of claim 5, wherein if at least one of the at least one tertiary user in the at least one secondary social network subsequently shares the promotion over the electronic communication network to at least one tertiary social network, each at least one tertiary social network including at least one quaternary user, a tertiary fractional incentive is automatically electronically transferred from the server account to the tertiary user account associated with the tertiary user and stored with the central distribution server.

8. The method of claim 5, wherein the promotion is sent to the user device over the electronic communication network upon the completion of a predetermined occurrence.

9. A system for managing a social commerce rewards platform over an electronic communication network, the system comprising:
a user device, the user device having electronic access to a user account hosted with the central distribution server and at least one primary social network, each at least one primary social network including at least one secondary user;
a commercial entity device, the commercial entity device having electronic access to an enterprise account; and
a central distribution server, the user device, the commercial entity device and the central distribution server in electronic communication over the electronic communication network,
wherein prior to the completion of an electronic commercial transaction between the user device and the commercial entity device over the electronic communication network through the central distribution server, the central distribution server adapted to electronically send a promotion to the user device over the electronic communication network, the promotion related to the commercial entity, the promotion containing at least one application program interface connection, the at least one application program interface connection adapted to share the promotion to the at least one primary social network; and if the promotion is shared by the user from the user device with at least one of the at least one primary social network over the electronic communication network, an incentive is automatically electronically transferred by the central distribution server from the enterprise account to a server account and subsequently a primary fractional incentive is automatically electronically transferred by the central distribution server from the server account to the user account.
